(19) United States
(12) Patent Application Publication
(10) Pub. No.: US 2008/0129133 A1
(43) Pub. Date: Jun. 5, 2008

(54) Electric Actuator

(75) Inventors: Peter Taube, Gibsonia, PA (US); Bradley A. Trago, Blacksburg, VA (US); Wolfgang Becker, Waldenbuch (DE); Dennis Van Zee, Durand (IL); Ulrich Rueger, Germering (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Danaher Motion Stockholm AB, Stockholm (SE)

(21) Appl. No.: 10/594,869

(22) PCT Filed: Mar. 31, 2004
(86) PCT No.: PCT/SE04/00500

§ 371 Date: Dec. 7, 2007

(51) Int. Cl. H02K 7/06; B62D 5/04; B62D 3/06; B62D 3/08; F16H 25/22; F16H 25/24

(52) U.S. Cl. 310/80; 180/444; 74/424.71; 310/89

(57) ABSTRACT

The present invention relates to a device functioning as an electric motor or actuator (100, 100′) comprising: a housing (110) encapsulating a rotating member (120, 120′), one or several arrangements (130, 130′) for generating a magnetic field due to electrical current, a displaceable shaft (140, 140′) at least partly having exterior grooves (141, 141′), said rotating member having a portion (121, 121′) with inner grooves (122, 122′) corresponding to grooves on said shaft (140, 140′). The device comprises at least one magnetic element (150, 150′) arranged on an outer surface of said rotating member (120, 120′) substantially perpendicular to extension direction of said grooves (122, 122′) for interaction with said arrangement (130, 130′) and rotating said rotating member.

### FIELD OF THE INVENTION

The present invention relates to an electric motor or actuator.

### BACKGROUND OF THE INVENTION

Hydraulic motors and actuators are widely used within automotive and material handling industry. For example, in trucks, and especially fork lift trucks, hydraulic motors are used for steering, powering forklift up and down, tilting and a number of auxiliary functions, etc.

Even though hydraulic motors and actuators are relatively reliable, there are a number of problems with them. A hydraulic system is not environmentally favourable. Hydraulic motors need hydraulic oils to operate. This implies a need for refilling oil, risk of leakage etc. Yet, another problem with hydraulic actuators is maneuvering it. A hydraulic actuator, for example, is controlled by connecting tubes extending from the actuator to a controlling arrangement, such as a stick or control buttons. The controlling arrangement functions as a valve for hydraulic oil to and from the actuator. This means time and space consuming assembly, inaccurate control, limited design freedom causing an unfavourable ergonomic situation for the truck drivers, etc.

The hydraulic motors can be substituted by electric motors. However, the presently available electric motors have a number of disadvantages: large size, low efficiency, less reliability etc.

EP 0386771 relates a linear actuator wherein a load-bearing body or structure made of relatively heavy metal provides for flexibly supporting an electric motor, the output shaft of which is connected, via a belt drive, to a tubular shaft parallel to the output shaft of the motor, and connected in rotary manner, at a first point, to the load-bearing structure and, at a second point, to a plastic element integral with the load-bearing structure. The output member of the actuator 1 consisting of a screw coaxial with the tubular shaft and connected to the same via a recirculating-ball screw-nut-screw coupling. A linear actuator wherein a load-bearing body or structure made of relatively heavy metal provides for flexibly supporting an electric motor, the output shaft of which is connected, via a belt drive, to a tubular shaft parallel to the output shaft of the motor, and connected in rotary manner, at a first point, to the load-bearing structure and, at a second point, to a plastic element integral with the load-bearing structure; the output member of the actuator consisting of a screw coaxial with the tubular shaft and connected to the same via a recirculating-ball screw-nut-screw coupling.

EP 0780955 discloses an actuator with a ball screw arrangement wherein the system is built in order to facilitate assembling and disassembling of the system and to prevent an overload being applied to the stator of the electrical motor.

EP 1182765 discloses an electrical motor and ball screw arrangement where the ball screw is mounted at one end of a rotary shaft of the electrical motor.

EP 1320174 discloses a compact electromechanical linear actuator with a ball screw arrangement fastened to one end of a rotor in an electrical motor.

U.S. Pat. No. 5,086,861 disclose a steering actuator with a ball screw arrangement attached to one of a planetary gear attached to a rotor shaft of an electrical motor.

U.S. Pat. No. 5,590,732 relates to an electrically assisted power steering system for a motor vehicle including a housing, a shaft slidably supported in the housing, a ball-and-nut mechanism operatively mounted on the shaft, and an electric motor mounted in the housing for transmitting rotary force from the electric motor through the ball-and-nut mechanism to the shaft. The ball-and-nut mechanism including a nut assembly disposed around the shaft and having one end rockably and rotatably supported in the housing by a four-point contact bearing or an automatic aligning bearing, and a plurality of balls movably held between an opposite end of the nut assembly and a screw groove defined in the shaft.

U.S. Pat. No. 6,202,498 relates to an axial displacement arrangement in the form of a ball screw and nut achieving a highly compact configuration by effecting ball recirculation entirely within the ball screw shaft. The ball recirculation portion of the ball screw shaft is axially short with respect to an elongated driven nut. As the nut is rotated, illustratively by an electric motor coupled thereto, the ball screw shaft is displaced axially along an axial support member. The axial support member has radially outward extending splines, and the ball recirculation portion of the ball screw shaft has radially inward extending splines, the inward and outward splines being arranged to face one another whereby a linear ball bearing region is formed. The linear ball bearing permits the ball recirculation arrangement and its associated actuation element to be displaced axially along the support element, but is precluded from rotating. A segmented ball recirculation end cap arrangement prevents the linear ball bearings from escaping axially from between the ball groove spine arrangement and the axial support element.

U.S. Pat. No. 6,492,753 disclose an electrical motor with variable axial rotor/stator alignment. The rotor is movable with respect to both the stator and the shaft while still transferring torque to the shaft. The solution does not use a ball screw arrangement.

Other less relevant documents include:

U.S. Pat. No. 4,742,882, U.S. Pat. No. 4,841,790, U.S. Pat. No. 4,893,518, U.S. Pat. No. 5,921,344, U.S. Pat. No. 5,988,311, U.S. Pat. No. 6,186,268, U.S. Pat. No. 4,828,062, U.S. Pat. No. 4,842,090, U.S. Pat. No. 5,083,626, U.S. Pat. No. 5,685,390, U.S. Pat. No. 5,975,234, U.S. Pat. No. 6,155,376.

### SUMMARY OF THE INVENTION

The main objective of the present invention is to provide an electric motor or actuator, which solves above-mentioned problems.

The electric motor is intended for use as a linear steering motor in e.g. lift trucks, pallet loader, golf car or any other power steered vehicles, especially counter balance lift trucks. It also may assist pinion and rack steering devices. However, other applications areas are possible. The main object of the invention is to replace the hydraulic systems in the intended application area.

The advantages of the present invention include:
Small and compact size (fits in the space for a hydraulic cylinder allowing easy upgrade of existing systems),
Environmentally clean (no need for hydraulic oils),
Efficient (saves battery and increases run time per charge)
Variable operating voltages, the invention allows for variations able to handle any voltage from low voltages such as 12V and below to high voltages such as 400 V and above 36/48 V and 72/80 V.
Improved acoustical performance (a hydraulic pump is very noisy compared to the present invention)
Reduced part count (very few components needed to create a system)
Reduced maintenance and warranty (from reduced part count and leakage)
Simplified installation—labour savings
Flexibility & design freedom—no hoses to steering wheel
Improved safety—since it is an electrical system there is the possibility to limit traction speed or lift height when steering (or vice versa)
Improved precision over a hydraulic system, which allows use of wire guidance systems and navigation systems such as laser navigation. These systems were previously reserved for smaller trucks where electric steering was available.

For these reasons, a device functioning as an electric motor or actuator is provided comprising: a housing encapsulating a rotating member, one or several arrangements for generating a magnetic field due to electrical current, a displaceable shaft at least partly having exterior grooves, said rotating member having at least a portion with inner grooves substantially corresponding to grooves on said shaft, The device further comprises at least one magnetic element arranged on an outer surface of said rotating member substantially perpendicular to extension direction of said grooves for interaction with said arrangement and rotating said rotating member. According to one aspect of the invention, the rotating element is a ball nut and the shaft is arranged as ball screw.

According to a second aspect of the invention, the rotating element is a nut. The shaft may be at least partly threaded.

Preferably, the nut on its outer surface is provided with a carrying sleeve for carrying said magnetic elements. The sleeve is provided with a flat portion and/or grooves for receiving said magnetic elements, which allows using commercially available magnets and easier assembly. An air gap may be arranged between said magnetic element and said sleeve.

The shaft can be made in sections of different parts, which can be made of different material.

The invention also relates to a device functioning as an electric motor or actuator comprising: a housing encapsulating a rotating member, one or several arrangements for generating a magnetic field due to electrical current, a displaceable shaft at least partly being arranged as a ball screw, said rotating member having a portion being provided as a ball nut. The magnetic elements arranged on an outer surface of said rotating member substantially parallel with extension of said shaft for interaction with said arrangement and rotating said ball nut. The outer surface of the nut may comprise a sleeve for receiving said magnetic element. Preferably, the sleeve is made of a laminated material. The shaft comprises a ball return.

In one embodiment the ball return comprises a notch arranged diagonally on the ball nut, a preload system, a return cap and a wiper arranged between the return cap and the shaft, grooves or ball tracks in which the balls run.

In another embodiment, the ball return comprises a single liner screw in which a notch forces balls passing through the notch to change track to the adjacent track.

According to one embodiment the ball return comprises a ball nut having multi linear ball return.

According to yet another embodiment, the ball return comprises a single- or multi liner system, in which the balls are lead back after each circulation around the shaft and the liner picks the balls out of a ball track and guides them with its path over the portion between the ball tracks of the shaft.

The ball return may also comprise a shaft provided with a return cap having a return channel wherein return cap system picks the balls up at one end of the nut and lead them back, through a hole in the nut, to the other side.

The ball return may also comprise a liner return placed in the shaft and the balls are lead through its path over a portion between the ball tracks of the nut

Preferably, the shaft comprises means for transforming rotation of the nut to an axial movement. The housing may at least partly be filled with a lubrication agent.

The invention also relates to a vehicle having steering wheels and including an actuator comprising: a housing encapsulating a rotating member, one or several arrangements for generating a magnetic field due to electrical current, a displaceable shaft at least partly having exterior grooves, said rotating member having a portion with inner grooves corresponding to grooves on said shaft. The magnetic elements are arranged on an outer surface of said rotating member substantially parallel with extension of said grooves for interaction with said arrangement and rotating said rotating member.

### SHORT DESCRIPTION OF THE DRAWINGS

The present invention is described more closely with reference to exemplary embodiments illustrated in attached drawings, in which:

FIG. 1 is exterior view of an arrangement according to the invention,

FIG. 2 is a sectional view of along line II-II illustrating an embodiment according to the first aspect of the present invention,

FIG. 3 is side view of the embodiment illustrated in FIG. 1,

FIG. 4 is a cross section view along line IV-IV in FIG. 1,

FIG. 5 is a second embodiment of the invention,

FIGS. 6-10 illustrate different ball return systems used in the invention,

FIG. 11 is a sectional view of along line II-II illustrating an embodiment according to the second aspect of the present invention, and

FIG. 12 is an exemplary embodiment illustrating schematically the invention in a steering application.

### DETAILED DESCRIPTION OF THE PREFERRED EMBODIMENTS

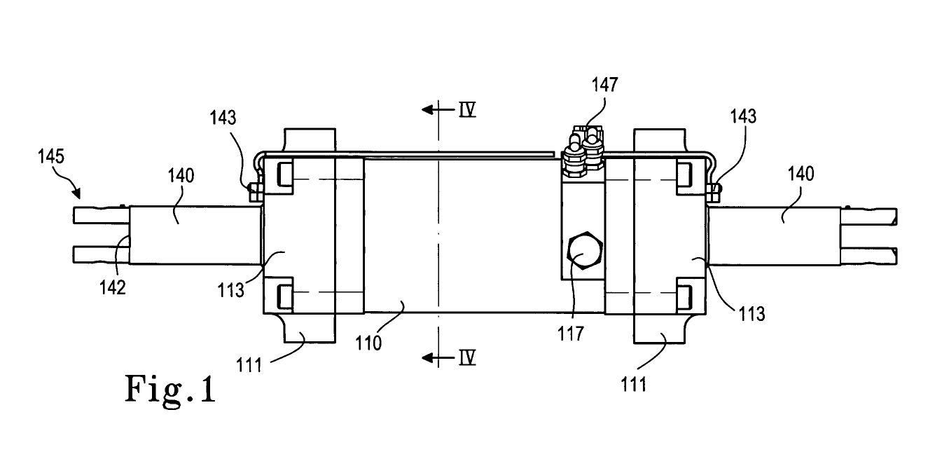

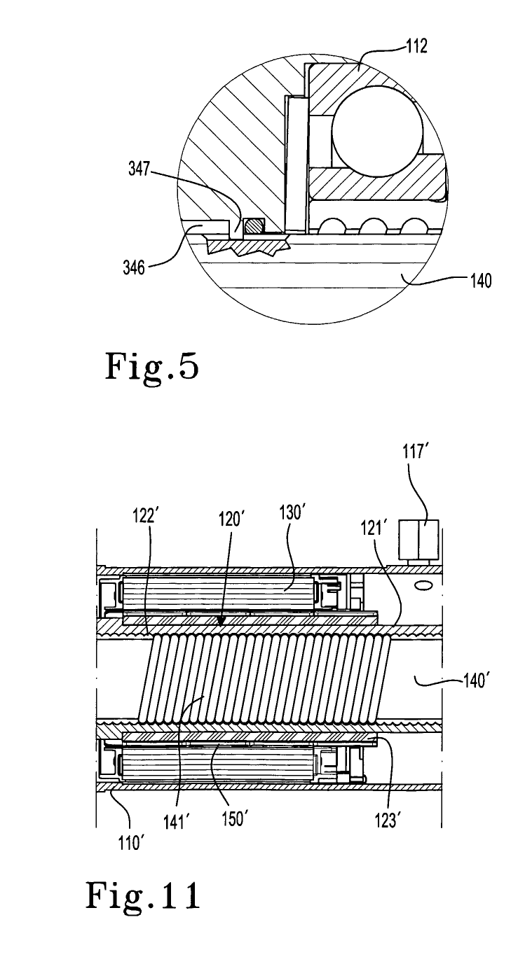

In the following, the invention will be described with reference to preferred embodiments, illustrated schematically in FIGS. 1-9 according to a first aspect of the invention and FIG. 10 according to a second aspect of the invention. The arrangement according to the invention may work as an actuator or a motor for providing a linear force. It may also work as a generator converting a linear movement to electrical energy. However, in the following “actuator” is used as a general term.

FIG. 1 is an exterior view of an actuator 100 according to the invention. The actuator comprises a housing 110 having ends 113 and supports 111 at each end.

A shaft 140 extends through the actuator and is provided with connection portions 145. Strain-relief connectors for electrical conductors are denoted with 147. The housing can be made of wrapped steel, steel tube, cast or any other suitable material. The shaft is made of steel or any other suitable material.

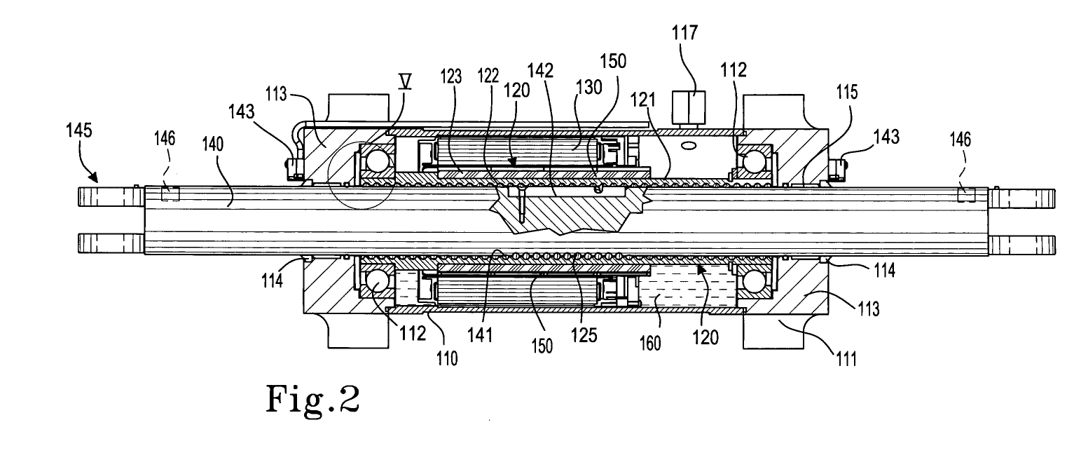

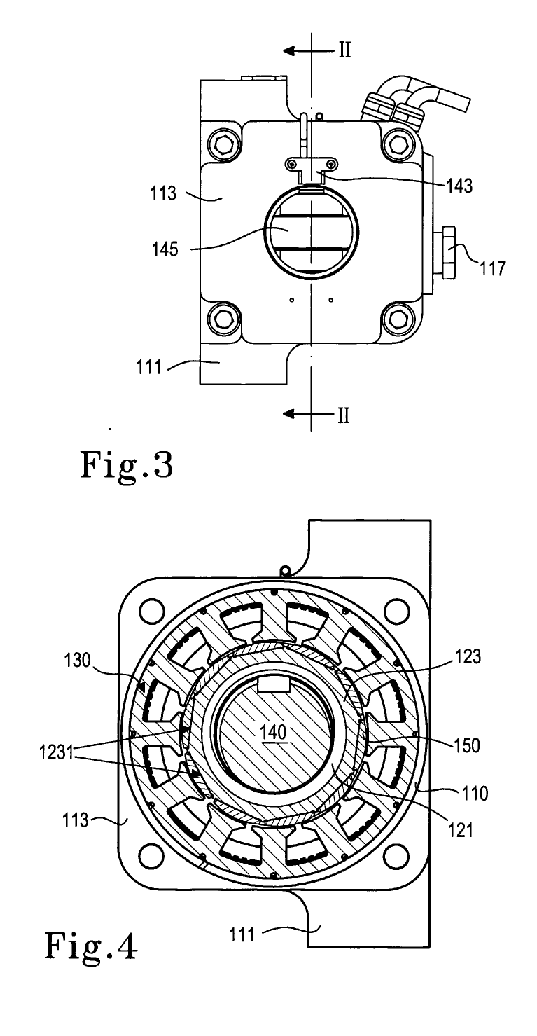

FIG. 2 illustrates a cut through the actuator of FIG. 3 along line II-II; also FIGS. 3 to 5 are considered in following description. Inside the housing 110 is arranged a rotating member 120 comprising a ball nut member 121 and mounted on bearings 112 at each end. One or several stators 130 are disposed on the inner surface of the housing.

The ball nut, shaped substantially cylindrically (or any other suitable shape), is provided with substantially helicoidally shaped grooves 122 for receiving bearing balls 125. It is also possible to provide the grooves at least on some section of the ball nut. The ball nut is shaped stepped providing a space on one end portion for receiving and positioning a sleeve 123. The sleeve 123 has an interior shape corresponding to the outer surface of the ball nut and an outer surface comprising portions 1231 for receiving a number of magnetic elements 150, arranged for interacting with the stators 130 and rotating the ball nut. Most preferably, substantially flat portions are arranged as grooves. Thus, the ball nut is rotated directly by the magnetic elements interacting with the stators.

The grooves for receiving magnetic elements fix the elements in a straight manner so that they do not slide during the assembly process. The magnetic elements are glued according to one preferred process. However, they may also be screwed or otherwise attached to the sleeve. It is also possible to use a tape, wrapper, stocking or bandage as an additional protection and/or fixing layer.

The ball nut can be made of steel e.g. 19MnCr5, plastic or any other suitable material. Additionally, a material, which blocks, diverts or minimizes the magnetic field from the magnetic elements to attract the balls 125, can be used. Moreover, an air-gap may be provided between the magnetic element and the sleeve to reduce the magnetic force. However, calculations have been shown that the effect of the magnetic fields from the magnetic elements is negligible.

The balls can be made of steel, ceramic or any other suitable material. Furthermore, the shaft can be made of metallic material such as steel, plastic or any other suitable material in one or several pieces. Making the shaft in several pieces allows manufacturing advantages. It also allows using different features for the motor.

The horizontally displaceable shaft 140 (with respect to the plane of the drawing) extends through the ball nut. The shaft is at least partly shaped as a ball screw, comprising outer grooves 141, corresponding to the grooves of the ball nut, for receiving the bearing balls 125. In this case, the middle section of the shaft is arranged as the ball screw. The shaft is provided with a ball return arrangement 142, which will be described more closely below.

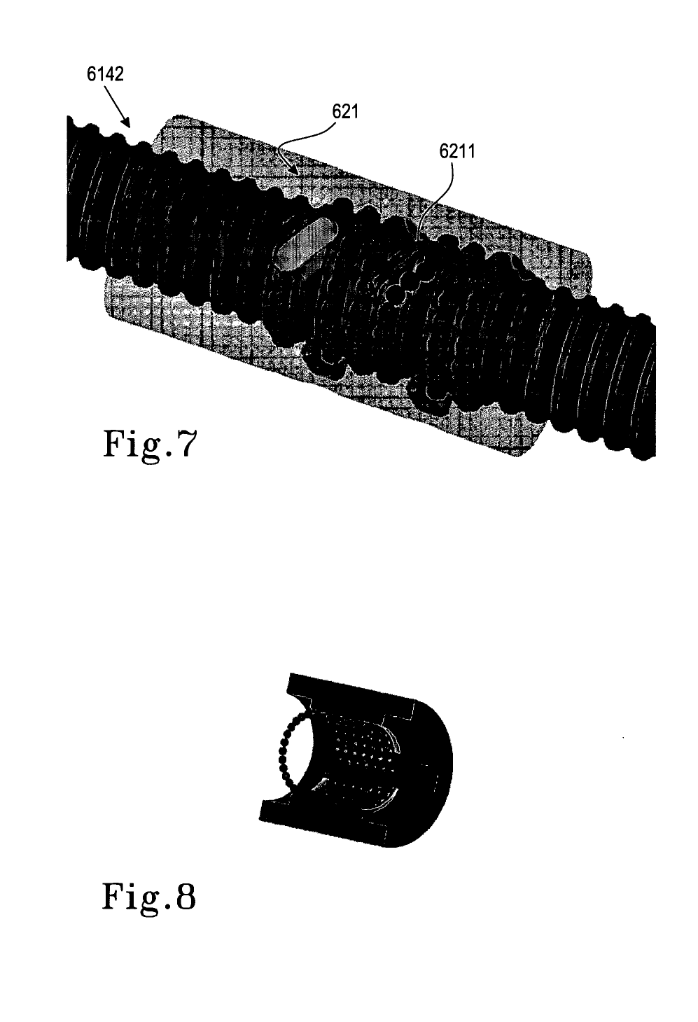

FIGS. 6-9 illustrate different arrangement of the ball returns, which can be used in the actuator of the present invention.

A first preferred embodiment of a ball return system employed in the invention is illustrated in FIG. 6. The system comprises notch 6211 arranged diagonally on the ball nut 621, a preload system 6212, a return cap 6213 and a wiper 6214 arranged between the return cap and the shaft 6142. The shaft further comprises grooves or ball tracks 6141 in which the balls 6125 run.

FIG. 7 illustrates the ball return with single liner screw according to FIG. 6, in which the notch 6211 forces balls 6125 passing through the notch to change track to the adjacent track.

FIG. 8 is a cut through a ball nut having multi liner ball return.

In the single- and multi liner system the balls are lead back after each circle around the shaft. The liner picks the balls out of the ball track and guides them with its path over the portion between the ball tracks of the shaft.

FIG. 9 is yet another example of the ball return, in which the shaft 9141 is provided with a return cap 9147 having a return channel 9148. The return cap systems picks the balls up at one end of the nut and lead them back, through a hole in the nut, to the other side.

FIG. 10 is the most preferred ball return system according to the invention. The ball return is very similar to the usual multi liner. The drawing shows only one return path.

The difference is that the liner return 10142 is placed in the shaft 10141 and the balls 10125 are lead through its path over the portion between the ball tracks 10122 of the nut. Thus, in this case seven circles of balls are provided. After each circle around the shaft, the balls will be carried back about the value of the ball track lead 10148.

The actuator operates in following way: A magnetic field is generated when electric current flows through the conductors of the stator and produces a magnetic field that has both a north and a south pole. The electric motor is essentially a spinning electromagnet. This electromagnet interacts with the permanent magnetic field of a set of opposing field magnets (magnetic elements). The interaction of the north and south pole of the electromagnet and the north and south poles of the field magnets produces a torque, which tends to spin the sleeve and the ball nut. As the ball nut spins, the magnetic poles of the magnetic elements are alternately reversed north to south and back again. As the nut rotates, electrical energy is transformed into mechanical energy and the balls force the shaft to rotate. If the shaft is prevented to rotate, it is displaced linearly. In this case sidewise, i.e. with respect to the plane of the drawing.

Obviously, the shaft does not have to extend from both sides of the housing and only one side is also possible.

Additionally, the housing may partly be filled with a lubrication agent 160, such as an oil, e.g. through a valve 117. Using oil allows overcoming the problems with temperature range of, for example grease, and also allowing better filling possibilities.

The motor further comprises means for detecting the end positions and/or the centre position, e.g. a magnetic element 146 arranged on the shaft and a Hall element 143 on one end.

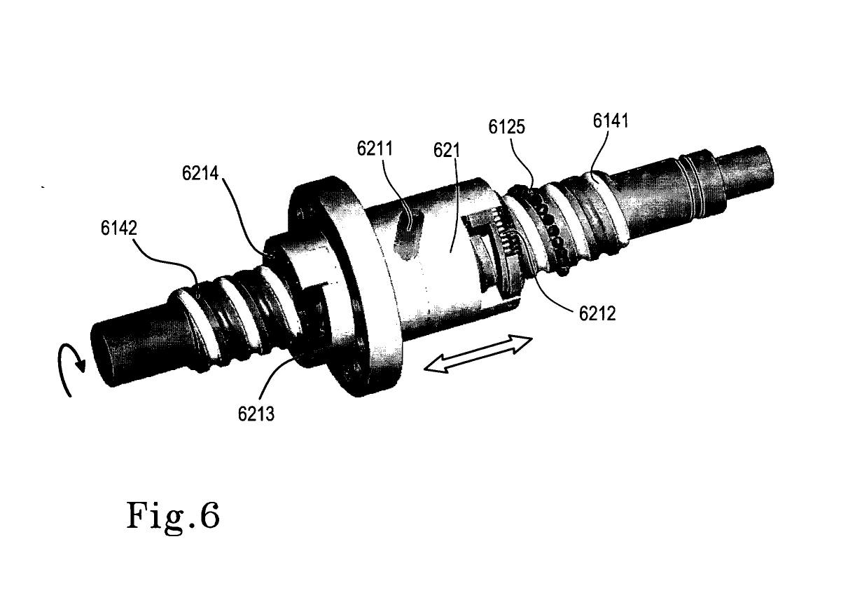

The ends of the shaft are provided with receiving arrangement for receiving and fixing other axis for example connected to steering wheels of a vehicle. As the shaft is fixed and cannot rotate, the rotation of the ball nut is transformed to an axial movement. It is also possible to achieve the same result by arranging an axial groove 346, as illustrated in FIG. 5, in the longitudinal direction of the shaft and a projection 347 in the ends, which stops the rotation of the shaft.

The ends of the shaft may also be provided with dampers to absorb forces due to undesired collisions.

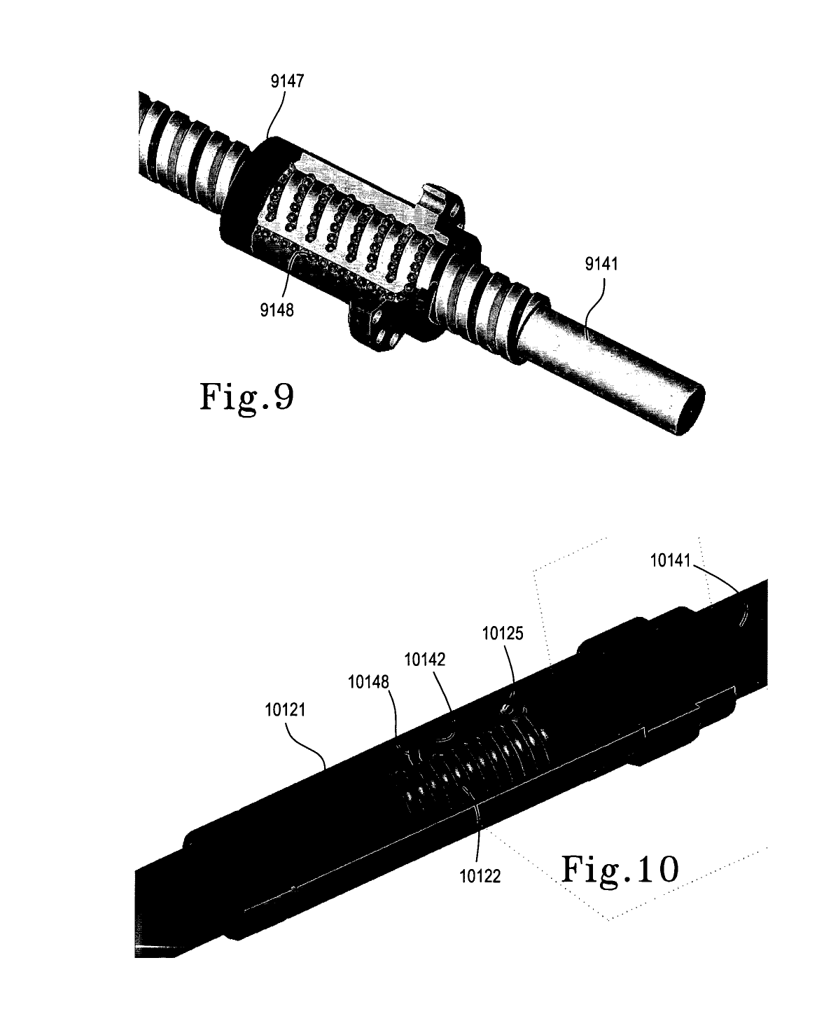

Clearly, the invention is not limited to the ball nut/screw based embodiment as described and illustrated earlier. The embodiment 100′ of FIG. 11 illustrates an example in which an ordinary (acme) screw/nut solution is used. Consequently, the shaft 140′ and the nut 121′ of the rotating element 120′ are arranged with threads 141′ and 122′, respectively. In same way as the previous example, the nut 121′ is provided with the sleeve 123′ for receiving magnetic elements 150′. Likewise, in this case the stators actuator operates according to the previous example.

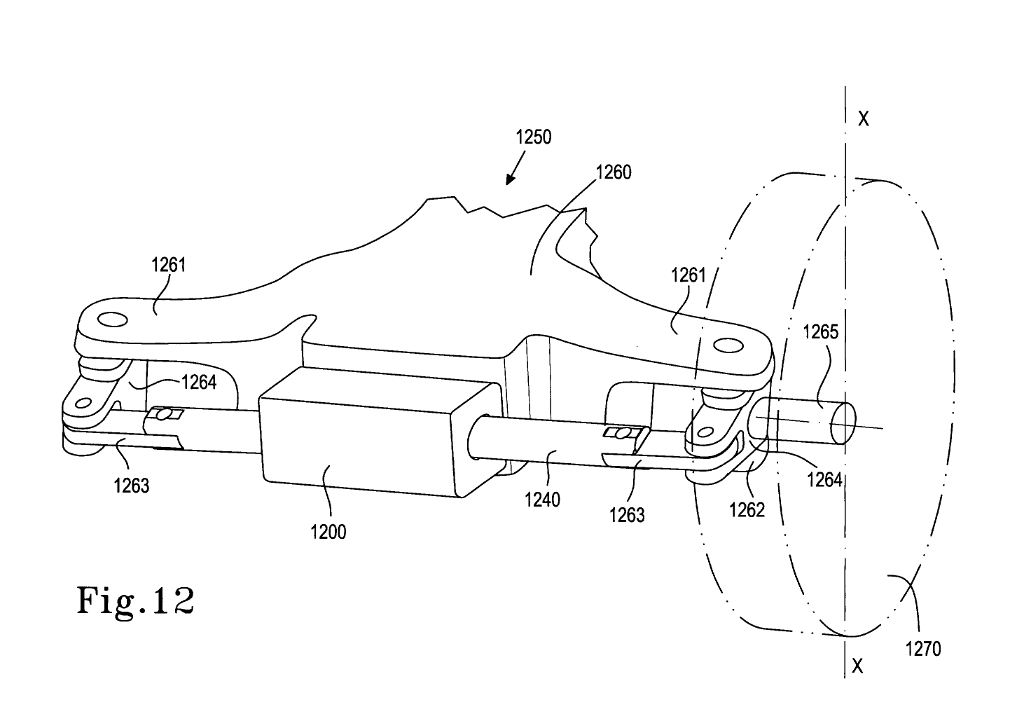

FIG. 12 illustrates a wheel suspension system 1250 employing a power steering motor 1200 according to a preferred embodiment of the invention. The system comprises a frame 1260, having upper and lower link arms 1261 and 1262, respectively. The motor 1200 is arranged in the mid section of the frame. The ends of the shaft 1240 are connected through links 1263 to joints 1264, which through taps 1265 are connected to the wheels 1270 (only one illustrated). Consequently, when the shaft 1240 is axially displaced, the joints 1264 will follow the movement of the shaft resulting in displacement and turn of the wheels around X axis. The steering may be applied on front or rear wheels of a vehicle.

The invention is not limited to the shown embodiments but can be varied in a number of ways without departing from the scope of the appended claims and the arrangement and the method can be implemented in various ways depending on application, functional units, needs and requirements etc.

1. A device functioning as an electric motor or actuator comprising:
a housing encapsulating a rotating member,
one or several arrangements for generating a magnetic field due to electrical current,
a displaceable shaft at least partly having exterior grooves,
said rotating member having at least a portion with inner grooves substantially corresponding to grooves on said shaft,
a carrying sleeve being arranged to be provided on an outer surface of said rotating member substantially perpendicular to extension direction of said grooves for interaction with said arrangement and rotating said rotating member;
wherein said sleeve has an interior shape corresponding to an outer surface of the rotating member and an outer surface comprising portions for receiving a number of magnetic elements, said portions being arranged as flat portion and/or grooves for receiving said magnetic elements.

2. The device of claim 1, wherein said rotating element is a ball nut.

3. The device of claim 2, wherein said shaft is arranged as ball screw.

4. The device of claim 1, wherein said rotating element is a nut.

5. The device of claim 4, wherein said shaft is at least partly threaded.

6. The device of claim 1, comprising an air gap between said magnetic element and said sleeve.

7. The device according to claim 1, wherein said shaft is made in sections of different parts.

8. The device of claim 7, wherein said parts are made of different material.

9. A device adapted to function as an electric motor or actuator, the device comprising:
a housing encapsulating a rotating member,
one or several arrangements for generating a magnetic field due to electrical current,
a displaceable shaft at least partly being arranged as a ball screw,
said rotating member having a portion being provided as a ball nut,
magnetic elements arranged on an outer surface of a carrying sleeve arranged on said rotating member substantially parallel with extension of said shaft for interaction with said arrangement and rotating said ball nut;
wherein said sleeve has an interior shape corresponding to an outer surface of the rotating member and an outer surface comprising portions for receiving a number of magnetic elements, said portions being arranged as flat portion and/or grooves for receiving said magnetic elements.

10. The device of claim 9, wherein said sleeve is made of a laminated material.

11. The device of claim 10, wherein said shaft comprises ball return.

12. The device of claim 11, wherein said ball return comprises a notice arranged diagonally on the ball nut, a preload system, a return cap and a wiper arranged between the return cap and the shaft, grooves or ball tracks in which the balls run.

13. The device of claim 12, wherein said ball return comprises a single liner screw in which a notch forces balls passing through the notch to change track to the adjacent track.

14. The device of claim 12, wherein said ball return comprises a ball nut having multi linear ball return.

15. The device of claim 12, wherein said ball return comprises a single- or multi liner system, in which the balls are lead back after each circulation around the shaft and the liner picks the balls out of a ball track and guides them with its path over the portion between the ball tracks of the shaft.

16. The device of claim 9, wherein the shaft is provided with a return cap having a return channel, wherein return cap system picks the balls up at one end of the nut and lead them back, through a hole in the nut, to the other side.

17. The device of claim 12, wherein said ball return comprises a liner return placed in the shaft and the balls are lead through its path over a portion between the ball tracks of the nut.

18. The device of claim 9, wherein said shaft comprises means for transforming rotation of the nut to an axial movement.

19. The device of claim 9, wherein said housing is at least partly filled with a lubrication agent.

20. A vehicle having steering wheels and an actuator, the actuator comprising:
a housing encapsulating a rotating member,
one or several arrangements for generating a magnetic field due to electrical current,
a displaceable shaft at least partly having exterior grooves,
said rotating member having a portion with inner grooves corresponding to grooves on said shaft,
a carrying sleeve having magnetic elements arranged on an outer surface of said sleeve, being arranged on said rotating member substantially parallel with extension of said grooves for interaction with said arrangement and rotating said rotating member;
that wherein said sleeve has an interior shape corresponding to an outer surface of the rotating member and an outer surface comprising portions for receiving a number of magnetic elements, said portions being arranged as flat portion and/or grooves for receiving said magnetic elements.

21. A method of actuating a device functioning as an electric motor or actuator, wherein the device comprises:
a housing encapsulating a rotating member,
one or several arrangements for generating a magnetic field due to electrical current,
a displaceable shaft at least partly being arranged as a ball screw,
said rotating member having a portion being provided as a ball nut, and
wherein the method comprises:
arranging magnetic elements on an outer surface of said rotating member substantially parallel with extension of said shaft for interaction with said arrangement and rotating said ball nut, and energizing said stators to rotate said rotating member and transforming station of said rotating member to a linear movement.

22. A carrying sleeve for use in a device functioning as an actuator, said carrying sleeve comprises an outer surface provided with at least one space for receiving at least one magnetic element, and inner space for mounting on an outer surface of a rotatable member,
wherein
said space comprises portions for receiving a number of magnetic elements, said portions being arranged as flat portions and/or grooves for receiving said magnetic elements.
